(19) United States
(12) Patent Application Publication
(10) Pub. No.: US 2026/0117802 A1
(43) Pub. Date: Apr. 30, 2026

(54) INTERMEDIATE HYDRAULIC SYSTEM AND METHOD OF USE

(71) Applicant: COUNTRY MECHANICAL SERVICES, Lethbridge County (CA)

(72) Inventor: Brad HANDSAEME, Lethbridge County (CA)

(21) Appl. No.: 19/470,357

(22) PCT Filed: Mar. 31, 2023
(86) PCT No.: PCT/CA2023/050437

§ 371 Date: Sep. 29, 2025

(51) Int. Cl. F15B 1/02; F15B 1/033; F15B 1/16; F15B 21/08

(52) U.S. Cl. CPC F15B 1/021; F15B 1/033; F15B 1/165; F15B 21/087; F15B 2201/205; F15B 2201/3152; F15B 2201/51; F15B 2211/50518; F15B 2211/50536; F15B 2211/6653; F15B 2211/6654; F15B 2211/6656

(57) ABSTRACT

Embodiments of an intermediate hydraulic system and method of use are disclosed, the system for receiving hydraulic fluid from at least one hydraulic power source and transmitting the hydraulic fluid to at least one hydraulic implement. The system may comprise at least one selector valve, at least one accumulator, and at least one valve controller, each in fluid communication one with the other and operative to receive and transmit hydraulic fluid therebetween, and at least one processor for automatically controlling hydraulic fluid flow and pressures through the system in real time.

### FIELD

Embodiments herein are related generally to hydraulic systems and, specifically, to intermediate hydraulic systems and methods of use for receiving hydraulic power from a hydraulic power source and transmitting hydraulic power to a hydraulic implement in a controlled manner.

### BACKGROUND

Intermediate hydraulic systems are known for receiving hydraulic power from a hydraulic power source (i.e., hydraulic fluid pump and reservoir) and transmitting hydraulic power to a hydraulic implement (i.e., pressure-driven mechanical device). Known systems are “intermediate” in that they are disposed along at least one hydraulic fluid line connecting the power source to the implement, which allows the systems to control the hydraulic power applied by the power source to the implement. In particular, known systems comprise valves, chambers, and control modules that operate together to control the flow and pressure of hydraulic fluid within the at least one hydraulic fluid line.

One known intermediate hydraulic system is found in hydraulic disc brakes for vehicles. Generally, hydraulic disc brakes operate by using hydraulic power to actuate a pair of brake caliper pistons mounted on opposite sides of a brake disc. Hydraulic power is generated by a pump that propels hydraulic fluid (e.g., oil) from a reservoir into a hydraulic fluid line connected to the brake caliper pistons. The fluid exerts pressure on the pistons, which causes the pistons to frictionally engage the brake disc. In such hydraulic disc brakes, a known intermediate hydraulic system may be disposed between the pump and pistons to control the flow and pressure of fluid applied to the pistons. Valves, chambers, and control modules within the system (e.g. check and block valves, a brake pedal, etc.) respond to passive inputs (e.g. pre-set pressure limits) and/or user inputs (e.g. actuation of the brake pedal) to maintain desired flow and pressure of fluid within the hydraulic disc brake. The configuration of such valves, chambers, and control modules for use in hydraulic disc brakes are well understood, however, it will be appreciated that different applications require different configurations.

For example, another known intermediate hydraulic system is used to control the flow and pressure of hydraulic fluid between a tractor and a towed implement. As described in United States Patent Application No. US 2017/0181378 A1 (“Brown”), it is desirable for tractors comprising a hydraulic fluid pump and reservoir to supply hydraulic power to a towed implement comprising pressure-driven mechanical devices (e.g., a baler). Unfortunately, hydraulic power supplied by any particular tractor may not be suitable for operating any particular towed implement (e.g., the tractor may not be able to provide constant hydraulic fluid pressure to the towed implement, as the tractor may draw down on hydraulic power for internal pressure-driven mechanisms such as hydraulic disc brakes). The intermediate hydraulic system described in Brown is intended to overcome this limitation by providing one or more hydraulic accumulators built into the towed implement, the hydraulic accumulators configured to receive hydraulic fluid from the tractor at a variable pressure and transmit hydraulic fluid to the towed implement at a constant pressure. The hydraulic accumulators comprise a bladder disposed within a pressurized chamber, the bladder in fluid communication with a hydraulic fluid line connected to both the tractor and the towed implement. In use, hydraulic fluid is constantly pumped through the fluid line from the tractor to the towed implement. When the hydraulic fluid pressure from the tractor exceeds the desired pressure for the towed implement (i.e., the fluid pressure exceeds the chamber pressure exerted on the bladder), the bladder is charged with excess fluid to stabilize the fluid pressure transmitted to the towed implement. When the fluid pressure from the tractor is less than the desired pressure for the towed implement (i.e., the fluid pressure is less than the chamber pressure exerted on the bladder), the bladder is constricted and discharges fluid to stabilize the fluid pressure transmitted to the towed implement. The system is controlled by a control module that comprises check and block valves operating in connection with an on/off pressure switch fixed to the towed implement. The control module ensures that the flow and pressure of fluid within the system is maintained within pre-set limits. It also allows an operator to turn the system on and off from the towed implement.

Although the intermediate hydraulic system described in Brown can be used for controlling the flow and pressure of hydraulic fluid between a tractor and a towed implement, the system is not configured to respond to user inputs while the system is operating (i.e., while the user is driving the tractor). Such inputs are critical to the operation of the towed implement, where pressure-driven mechanical devices within the towed implement must be activated, deactivated, or modulated in response to various conditions. For example, most towed agricultural implements need to be disabled (by deactivating certain hydraulic mechanisms) and/or raised from the ground (by activating certain hydraulic mechanisms) when the operator has completed a pass of a field and intends to turn around. Such activations, deactivations, and modulations require the flow and pressure of hydraulic fluid from the tractor to the towed implement to be controlled in real-time by the operator or electronic programming. Further, the intermediate hydraulic system described in Brown comprises a number of components that are individually fixed to and tied into the towed implement according to the particular hydraulic mechanisms and geometry of the towed implement. The system is very difficult, if not impossible, to transport between and optimize for use with different tractors and towed implements.

There remains a need for intermediate hydraulic systems and methods of use for receiving hydraulic power from a hydraulic power source and transmitting hydraulic power to a hydraulic implement in a controlled manner. In particular, there remains a need for intermediate hydraulic systems that can respond to user inputs in real-time during their operation and that are unitary, mobile, and modular to enable convenient maintenance, transportation, and optimization of the systems for different applications.

### SUMMARY

According to embodiments, an intermediate hydraulic system and method of use are disclosed herein.

In some embodiments, an intermediate hydraulic system for receiving hydraulic fluid from at least one hydraulic power source and transmitting the hydraulic fluid to at least one hydraulic implement is provided, the intermediate hydraulic system comprising at least one selector valve, at least one accumulator, at least one valve controller, and at least one processor for automatically controlling hydraulic fluid flow through the system in real time.

In some embodiments, the at least one selector valve comprises at least one input port for receiving hydraulic fluid into the valve, at least one of the input ports for receiving hydraulic fluid from the at least one hydraulic power source, and at least one output port for transmitting the hydraulic fluid to the at least on hydraulic implement.

In some embodiments, the at least one accumulator may be in fluid communication with the at least one selector valve, the accumulator being adapted and configured to control pressure fluctuations in the hydraulic fluid. The at least one accumulator may comprise a bladder accumulator. The at least one accumulator may further comprise a hydraulic fluid pressure gauge configured for detecting and measuring hydraulic fluid in the system.

In some embodiments, the at least one valve controller may be in fluid communication with the at least one selector valve and that at least one accumulator, the at least one valve controller having at least one input port for receiving hydraulic fluid into the valve controller, and at least one output port for transmitting the hydraulic fluid out from the valve controller. The at least one valve controller may comprise at least one bleed valve for diverting hydraulic fluids from the system. In some embodiments, the at least one bleed valve may be an automatic bleed valve, a manual bleed valve, or both.

In at least one processor for controlling the system, the processor configured for signaling/actuating the at least one selector valve, the at least one accumulator, and the at least one valve controller to regulate and maintain optimized, near-constant hydraulic fluid flow and pressure from the at least one hydraulic power source and through the system to the at least one hydraulic implement in real time.

According to embodiments, a method of automatically controlling hydraulic fluid flow between at least one hydraulic power source and at least one hydraulic implement is provided. In some embodiments, the method may comprise providing at least one selector valve in fluid communication with the at least one power source and the at least one hydraulic implement and configured to receive and transmit hydraulic fluid therebetween, providing at least one hydraulic fluid accumulator in fluid communication with the at least one selector valve for controlling pressure fluctuations, providing at least one selector valve controller in fluid communication with the at least one selector valve and the at least one accumulator configured to control, and operating the at least one hydraulic power source to drive the at least one implement wherein, during operation, the selector valve is automatically controlled to divert hydraulic fluid flow directly from the at least one hydraulic fluid source to the at least one hydraulic implement or to direct hydraulic fluid flow through the at least one accumulator and/or the at least one selector valve controller module to maintain near-constant pressure levels between the at least one hydraulic power source and the at least one hydraulic implement.

In some embodiments, at least one hydraulic implement may be towed by the at least one hydraulic power source. In some embodiments, the at least one hydraulic power source may be a tractor and the at least one hydraulic implement may be hydraulic-pressure driven agricultural equipment.

As will be appreciated, the intermediate hydraulic system and method of use described herein are operable to receive hydraulic power from a hydraulic power source and transmit hydraulic power to a hydraulic implement in a controlled manner. Specifically, the system and method allow an operator or electronic programming to control the flow and pressure of hydraulic fluid transmitted to the implement in real time. Further, the described system is unitary, modular, and mobile, which allows an operator to conveniently maintain, transport, and optimize the system for use with different power sources and implements. In addition to these appreciated benefits, the described system and method may also increase overall availability of hydraulic power to the implement (by stabilizing hydraulic power transmitted to the implement when hydraulic power is drawn down from the hydraulic power source for other functions), increase fuel efficiency and reduce harmful emissions (by reducing fuel use when less hydraulic power is required by the implement), prevent damage to the power source by absorbing and/or releasing back-pressure from the implement, and allow a wide range of power sources and implements to be used together regardless of their designs and specifications. Although embodiments of the system and method described herein are directed to agricultural applications (i.e. receiving hydraulic power from a tractor and transmitting hydraulic power to an agricultural implement), it will be appreciated that the system and method could be used in any other applications that require hydraulic power to be received from a power source and transmitted to a pressure-driven mechanical device (i.e. construction equipment, commercial vehicles, manufacturing, processing, etc.).

### BRIEF DESCRIPTION OF THE DRAWINGS

Embodiments of an intermediate hydraulic system and method of use are described herein having reference to the following Figures:

FIG. 1 is a side view of an intermediate hydraulic system, according to embodiments;

FIGS. 2A and 2B show top views of the intermediate hydraulic system of FIG. 1., FIG. 2A showing reference numbers of system components, and FIG. 2B showing hydraulic fluid flow lines, FIGS. 2A and 2B referred to collectively as FIG. 2, according to embodiments;

FIG. 3 is a flow diagram of hydraulic fluid within the intermediate hydraulic system of FIG. 1, according to embodiments; and

FIG. 4 is an electrical diagram of a processor (logic control) of the intermediate hydraulic system of FIG. 1, according to embodiments.

### DETAILED DESCRIPTION

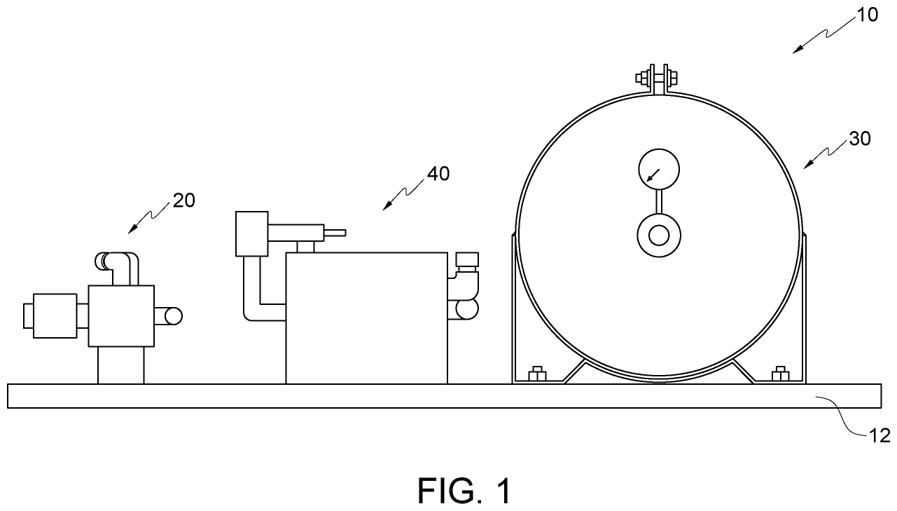

According to embodiments, an intermediate hydraulic system and method of use are disclosed. As will be appreciated, the intermediate hydraulic system and method of use are operable to receive hydraulic power from at least one hydraulic power source and to transmit hydraulic power to at least one hydraulic implement in a controlled manner. In particular, the presently described system and method allow an operator or electronic programming to automatically control the flow and pressure of hydraulic fluid transmitted to the implement in real time. Further, the described system is unitary, modular, and mobile, allowing an operator to efficiently maintain, transport, and optimize the system for use with different power sources and implements. The system will now be described in more detail having regard to FIGS. 1-4.

According to embodiments, an intermediate hydraulic system is provided, the intermediate hydraulic system being operable in connection with a variety of hydraulic power sources and hydraulic implements. For example, having regard to FIG. 1, intermediate hydraulic system 10 may be optimized for use in the agriculture industry, where the at least one hydraulic power source may be agricultural-related equipment, such as a tractor, and the at least one hydraulic implement may be a plow, seeder, baler, bale stacker, bale conveyor, raker, or another implement towed by a tractor. In such embodiments, system 10 may be used to automatically control the transmission of hydraulic power between the tractor and the implement to cause the implement to raise from the ground, lower into the ground, or perform other pressure-driven mechanical functions. In such embodiments, the pressure-driven functions may require hydraulic fluid to be pumped from the tractor to the implement, e.g., to raise the implement, or allowed to return from the implement to the tractor, e.g., to lower the implement. In such embodiments, intermediate hydraulic system 10 may be in hydraulic communication with the tractor and the implement via hydraulic fluid transfer lines, conduits, tubing, etc., and may be operable to control the pressure and flow of hydraulic fluid to enable efficient, convenient, and safe operation of the tractor and implement. Broadly, intermediate hydraulic system 10 may be operable in connection with a variety of hydraulic power sources having a hydraulic fluid pump and reservoir, such as excavators, cranes, trucks, ships, aircraft, stationary machinery, etc., and a variety of hydraulic implements comprising pressure-driven mechanical devices, such as trailers, machinery, etc.

Having regard for FIG. 1, intermediate hydraulic system 10 may comprise a plurality of modular components, the plurality of components being in hydraulic and/or electrical communication with one another and configured to controllably receive hydraulic power from at least one hydraulic power source (e.g., a tractor) and to transmit said hydraulic power to at least one hydraulic implement (e.g., pressure-drive agricultural machinery), as will be described.

According to embodiments, system 10 may comprise at least one selector valve module 20 operable to receive and transmit hydraulic fluid to and from the at least one power source, at least one accumulator module 30 operable to accumulate and regulate the fluid pressure of hydraulic fluid flowing through system 10, and, advantageously, at least one selector valve controller module 40 for maintaining a constant or near-constant fluid pressure between modules 20,30 and within system 10. In some embodiments, system 10 may further comprise at least one controller or processor operable to automatically control the operation of system 10 according to system inputs, including automatic inputs and/or user (passive) inputs. The at least one controller or processor may comprise the electronics system of the at least one hydraulic power source. That is, system 10 may be automatically controlled, in whole or in part, by the computer or processor of the at least one hydraulic power source (e.g., system 10 may be configured as a plug-and-play system incorporated into the electronics system of the tractor). System 10 may, in whole or in part, comprise a closed-loop, mobile system permanently or temporarily mounted upon a mounting or base 12 for easy installation and/or retrofitting into existing machinery.

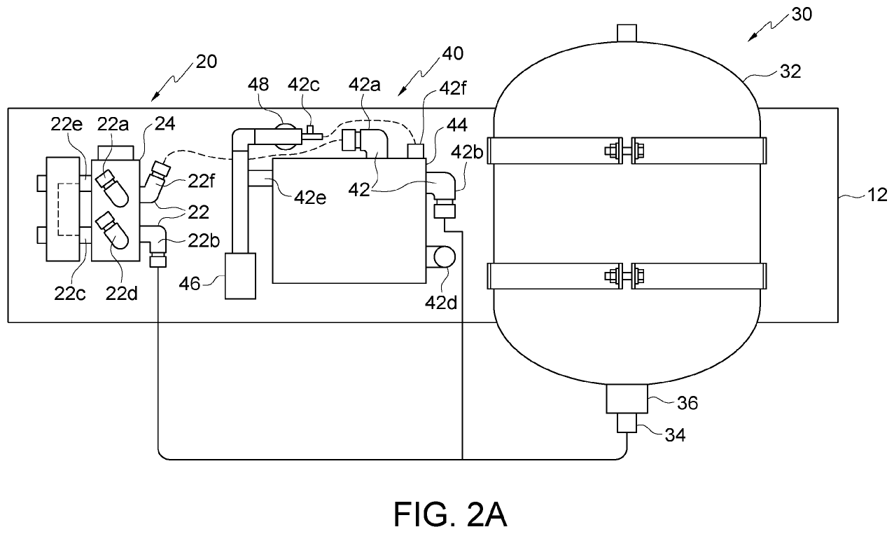

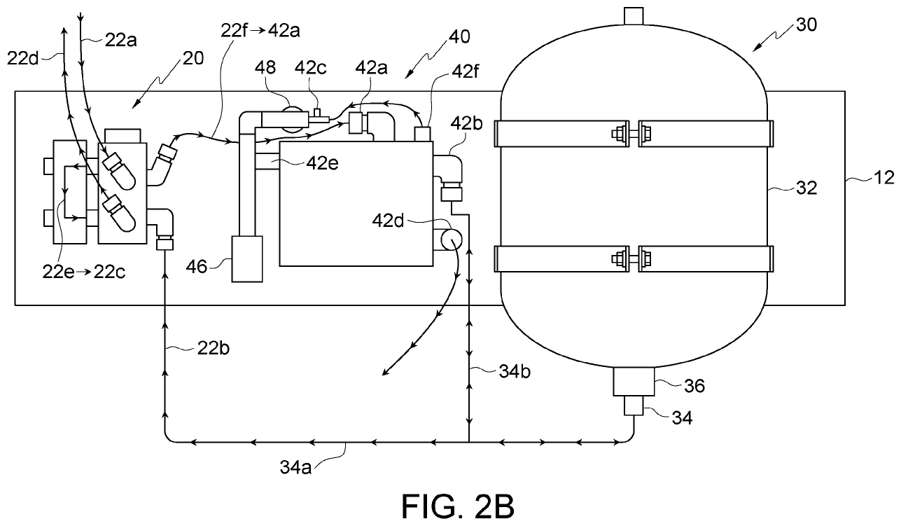

Having regard to FIG. 2A, a top view of the at least one selector valve 20 is shown. In some embodiments, selector valve 20 may be in fluid communication with the at least one power source (e.g., a tractor, not shown) and with the at least one hydraulic implement (e.g., agricultural equipment, not shown), selector valve 20 operative to controllably receive and transmit hydraulic therebetween. For example, advantageously, selector valve 20 may serve to divert (i.e., select) an optimized fluid flow path for hydraulic fluid flowing through system 10. In some cases, selector valve 20 may cause hydraulic fluid to bypass system 10 and flow directly from the at least one hydraulic power source to the at least one hydraulic implement. In other cases, selector valve 20 may cause hydraulic fluid to flow directly from the at least one power source back to the power source or otherwise, such flow being dependent upon which selector valve ports are in fluid communication with valve 20 (as will be described).

In some embodiments, the at least one selector valve 20 may comprise an on/off mechanism enabling for controlled flow in to and out from selector valve 20. The mechanism may be any suitable type of mechanical or electro-mechanical valve mechanism, including a solenoid valve. The type, number, and connectivity of selector valve(s) 20 will be appreciated based on the desired application and operation of system 10, and as operably connected to the electronics system of the at least one power source (e.g., the electronic controls of the tractor). It is contemplated that the at least one selector valve 20 may be operated, in whole or in part, via a controller and/or processor (e.g., the controls of a tractor), enabling selector valve 20 to be partially and/or entirely actuated automatically by the at least one hydraulic power source.

In some embodiments, the at least one selector valve 20 may comprise a plurality of ports 22 positioned within a valve housing 24, each plurality of ports 22 being in fluid communication via at least one hydraulic fluid lines (see arrows, FIG. 2B) to the at least one power source and/or to the at least one implement.

Fluid ports 22 may be sized, shaped, and configured in any manner suitable to enable controlled fluid transfer/transmission between components of system 10. Connection between fluid ports 22 and fluid lines may be in any manner suitable to enable controlled fluid transfer/transmission between components of system 10. For example, each of the plurality of fluid ports 22 may be sealingly engaged with fluid transfer lines, such engagement being configured for releasable engagement with fluid lines, such as via radial clamps, ridge grips, threading, etc., or configured for permanent engagement thereto, such as by welding. In some embodiments, each of the plurality of fluid ports 22 may be configured for ‘quick-release’, e.g., via a spring-actuated clamp, bayonet mount, etc., for quickly and easily installing fluid transfer lines to the plurality of ports 22. Such quick-release engagement means may allow an operator to sealingly connect or disconnect system 10 from the at least one power source and/or the at least one implement in a convenient and efficient manner.

Having specific regard to FIG. 2A, for example, the plurality of selector valve ports 22 may comprise at least six (6) valve ports 22, wherein some of the at least six ports 22 are input ports for receiving hydraulic fluid and at least of the at least six ports 22 are output ports for transmitting hydraulic fluid.

By way of explanation, at least one of the input fluid ports 22a may be configured to receive hydraulic fluid from the at least one power source, at least one of the input fluid ports 22b may be configured to receive hydraulic fluid from the accumulator 30, and at least one of the input fluid ports 22c may be configured to receive hydraulic fluid flowing through selector valve 20. By way of further explanation, at least one of the output fluid ports 22d may be configured to transmit hydraulic fluid to the at least one implement, at least one of the fluid output ports 22e may be configured to transmit hydraulic fluid within valve 20 (e.g., to input valve 22c), and at least one of the fluid output ports 22f may be configured to transmit hydraulic fluid to the selector valve controller module 40. The plurality of input and output valve ports 22 described herein are for illustrative purposes only and any configuration of number, flow direction, and connection of valve ports 22 within system 10 are contemplated.

As above, in some embodiments, valve housing 24 may be temporarily or permanently affixed to base plate 12, and/or to any other components of system 10. Housing 24 may comprise any suitable container known in the art including, without limitation, any suitable rigid and protective material.

As above, according to embodiments, system 10 may comprise at least one accumulator 30 operable to accumulate hydraulic fluid therein, controlling and regulating fluctuations in hydraulic fluid pressures within system 10, as needed/desired. In some embodiments, accumulator 30 may be in fluid communication with system 10 so as to receive hydraulic fluid flowing between the at least one power source and the at least one implement, accumulating said fluids and regulating discharge pressures thereof before fluids are discharged to the at least one implement.

In some embodiments, accumulator 30 may be in fluid communication with the at least one selector valve 20 so as to receive hydraulic fluid flowing through said valve 20 from the at least one power source and to accumulate and regulate the fluid pressures of hydraulic fluid being released from valve 20 to the at least one implement. Advantageously, accumulator 30 may further be in fluid communication with the at least one selector valve controller module 40 for optimizing constant hydraulic fluid pressures of hydraulic fluid being release from valve 10 to the at least one implement. In this manner, accumulator 30 may serve to controllably regulate fluid pressures within system 10 as such fluids flow in to and out from valve 20.

Having regard to FIG. 2A, accumulator 30 may comprise any known accumulation means known in the art, such as a bladder accumulator, for controlling fluid pressure fluctuations within system 10. In some embodiments, accumulator may form an outer pressure vessel 32 filled with at least one inert, compressed gas (e.g., nitrogen) and containing at least one bladder/diaphragm, such bladder formed from a resilient, elastomeric material (e.g., rubber). Hydraulic fluids entering accumulator 30 fill the bladder, causing the elastomeric material to expand and compressing the gas sealed within vessel 32. The compressed gas provides the compressive force on the hydraulic fluids such that, as the volume of the compressed gas changes, the pressure of the gas (and the corresponding pressure on the hydraulic fluids) changes inversely. For example, when pressures within accumulator 30 decrease, the compressed gas in the vessel 32 expands and pushes fluids stored within the accumulator 30 out into system 10, and vice versa.

Accumulator 30 may be in fluid communication with the at least one valve selector valve 20 (34a; FIG. 2B), the at least one selector valve controller 40 (34b; FIG. 2B), or both. In some embodiments, accumulator 30 may comprise at least one fluid port 34, for receiving and/or transmitting fluid into and out from vessel 32. In some embodiments, accumulator 30 may further comprise at least one pressure gauge 36 for detecting and measuring hydraulic fluid pressures within vessel 32. Accumulator gauge 36 may comprise any known means for measuring the pressure of a fluid, as well as any known means for displaying and/or relaying the measured pressure (e.g., analog display, digital display, electronic transceiver, etc.). As will be described in more detail below, accumulator gauge 36 may relay pressure measurements/information to control module.

Accumulator 30 may be pressurized by any means known in the art, including via a compressor in sealed, fluid communication with vessel 32. Accumulator 30 may be continuously pressurized, pressurized from time to time, and/or pressurized and sealed at the time of manufacture. In some embodiments, accumulator 30 may be pressurized to any range suitable in the art, including, without limitation, to between about 450 psi to 600 psi. Any pressure may be used, provided that it corresponds generally with the pressure of hydraulic fluid required or desired to operate the implement and is less than the maximum pressure of hydraulic fluid generated by the power source.

As above, in some embodiments, accumulator 30 may be temporarily or permanently affixed to base plate 12, and/or to any other components of system 10. Accumulator 30, vessel 32, port 34, and gauge 36 may comprise any suitable materials known in the art including, without limitation, any suitable rigid and protective material.

As above, according to embodiments, system 10 may comprise at least one valve control module 40 operable to optimize and maintain a constant or near-constant fluid pressure within system 10. In some embodiments, valve control module 40 may be in fluid communication with the at least one valve selector 20 and/or the at least one accumulator 30. In some embodiments, valve control module 40 may be positioned between the valve selector 20 and the accumulator 30, controlling and optimizing fluid pressures therebetween.

Having regard to FIG. 2A, a top view of the at least one valve controller 40 is shown. In some embodiments, valve controller 40 may be in fluid communication with the at least one valve selector module 20 and with the at least one accumulator 30. For example, advantageously, valve controller 40 may serve to divert (e.g., bleed) hydraulic fluid flowing through a first hydraulic fluid line to a second hydraulic fluid line, and/or to the external environment when hydraulic fluid pressures within system 10 exceeds a specific value, such as a pre-determined or pre-set value determined automatically (e.g., via electronic programming) and/or manually by operator.

In some embodiments, valve controller 40 may comprise an on/off mechanism enabling for controlled flow in to and out from controller 40. The mechanism may be any suitable type of mechanical or electro-mechanical mechanism, including a solenoid valve. The type, number, and connectivity of valve controller 40 will be appreciated based on the desired application and operation of system 10, and as operably connected to the electronics system of the at least one power source (e.g., the electronic controls of the tractor). It is contemplated that the at least one valve controller 40 may be operated, in whole or in part, via a processor (e.g., the electronic controls of a tractor), enabling selector controller 40 to be partially and/or entirely actuated automatically.

In some embodiments, the at least one valve controller 40 may comprise a plurality of controller ports 42 positioned within a controller housing 44, each plurality of ports 42 being in fluid communication, via at least one hydraulic fluid lines (see arrows, FIG. 2B), to the at least one selector valve module 20 and the at least one accumulator 30. In some embodiments, the at least one valve controller 40 may comprise at least one fluid release/vent valve (e.g., bleed valve), such bleed valves being an automatic bleed valve 46, manual bleed valve 48, both, and/or a combination thereof. In some embodiments, valve control module 40 may be operable to control the flow rates and pressures of hydraulic fluid within system 10, according to pre-set or predetermined pressure levels/limits, inputs received from the controller, and/or manually inputs received from an operator. The at least one bleed valves 46,48 may be adapted and configured for diverting hydraulic fluid within system 10, ensuring hydraulic fluid pressures are maintained within a range or below a predetermined level to not exceed predetermined pressure values (i.e., to ensure optimized hydraulic fluid flow to the at least one hydraulic implement, avoiding intermittent or inconsistent fluid flow to prevent disrupted operation (e.g., bouncing) and the like). In some embodiments, bleed valves 46,48 may each be actuated by any suitable means including, without limitation, mechanically, electronically, electro-mechanical, including a solenoid valve, or by any other on/off mechanism allowing for a controller volume of fluids to be diverted within or from system 10.

Fluid ports 42 may be sized, shaped, and configured in any manner suitable to enable controlled fluid transfer/transmission between components of system 10. Connection between fluid ports 42 and fluid lines may be in any manner suitable to enable controlled fluid transfer/transmission between components of system 10. For example, the plurality of fluid ports 42 may be sealingly engaged with fluid transfer lines, such engagement being configured for releasable engagement with fluid lines, such as via radial clamps, ridge grips, threading, etc., or configured for permanent engagement thereto, such as by welding. In some embodiments, the plurality of fluid ports 42 may be configured for ‘quick-release’, e.g., via a spring-actuated clamp, bayonet mount, etc., for quickly and easily installing fluid transfer lines to the plurality of ports 42. Such quick-release engagement means may allow an operator to sealingly connect or disconnect system 10 from the at least one power source and/or the at least one implement in a convenient and efficient manner.

Having specific regard to FIG. 2A, for example, the plurality of valve controller ports 42 may comprise at least six (6) valve ports 42, wherein some of the at least six ports 42 are input ports for receiving hydraulic fluid and at least of the at least six ports 42 are output ports for transmitting hydraulic fluid.

By way of explanation, at least one of the input fluid ports 42a may be configured to receive hydraulic fluid from the at least selector valve module 20, at least one of the input fluid ports 42b may be configured to receive/transmit hydraulic fluid to/from the accumulator 30 and further to transmit fluid to the at least one selector valve module 20 (to input valve 22b, via line 34a), and at least one of the input fluid ports 42c may be configured to receive hydraulic fluid flowing from automatic bleed valve 46, manual bleed valve 48, and/or valve control output port 42f. By way of further explanation, at least one of the output fluid ports 42d may be configured to transmit hydraulic fluid to the at least one power source, at least one of the fluid output ports 42e may be configured to transmit hydraulic fluid within valve controller 40, and at least one of the fluid output ports 42f may be configured to transmit hydraulic fluid to valve control input port 42c. The plurality of input and output valve ports 42 described herein are for illustrative purposes only and any configuration of number, flow direction, and connection of valve ports 42 within system 10 are contemplated.

As above, in some embodiments, valve housing 44 may be temporarily or permanently affixed to base plate 12, and/or to any other components of system 10. Housing 44 may comprise any suitable container known in the art including, without limitation, any suitable rigid and protective material.

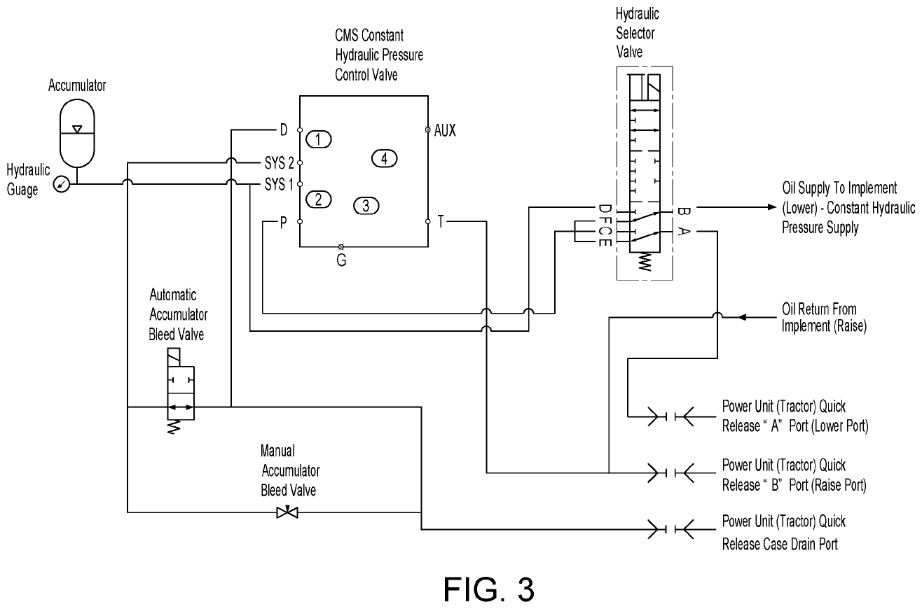

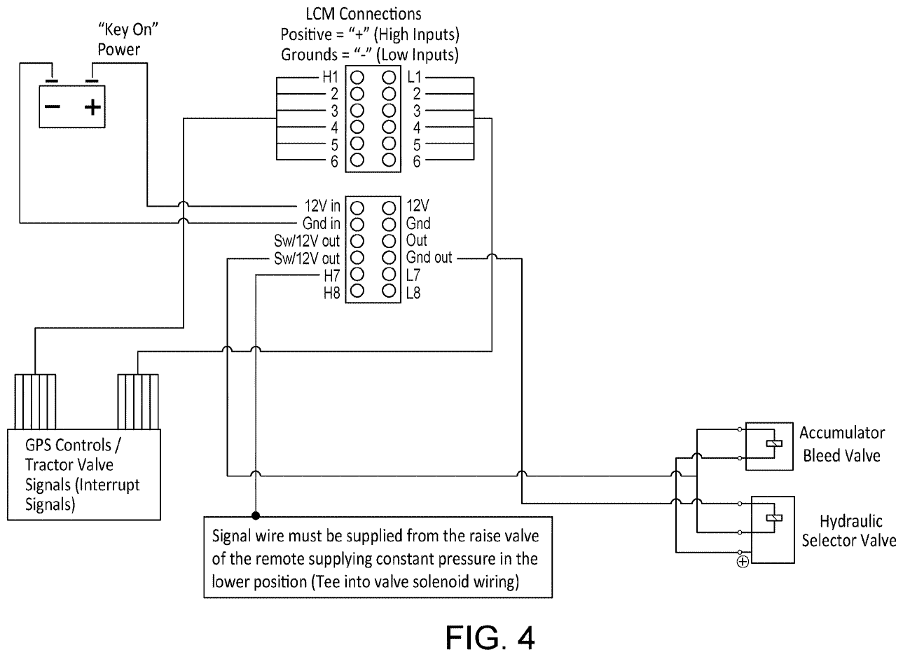

In some embodiments, having regard for FIGS. 3 and 4, system 10 processor may comprise a power source and/or logic controller for automatically operating system 10. Processor may serve to operate and control actuation (on/off) of the at least one selector valve 20, the at least one accumulator 30, and/or the at least one valve controller 40. In some embodiments, processor may be any suitable controller system, and comprise any electronic circuity necessary to operate system. In some embodiments, processor may be integrated with or within controller system of the at least one hydraulic power source, including the Global Positioning System (GPS) system of the at least one hydraulic power sources (e.g., a tractor). In this manner, system 10 may be configured as a plug-and-play, closed-loop hydraulic fluid control system that can be controlled, either in whole or in part, by the onboard computer system/electronic circuitry and the hydraulic fluid supply of the at least one hydraulic power source.

It will be appreciated that the processor may receive power from the at least one hydraulic power source and, during operation thereof, may transmit power to system 10. Further, advantageously, processor may be configured to modulate the power transmitted (either on/off or continuously) according to electronic signals generated by and received by the processor, in order to control the actuation of the at least one selector valve 30, the at least one accumulator 30, and the at least one controller valve 40. In particular, electronic control of system 10 may be according to pre-determined fluid pressure levels (i.e., programmed) to optimize the timing and fluid pressures transmitted to the at least one hydraulic implement. The at least one hydraulic power source (electronic circuitry) may comprise logic gates and other circuit components arranged in any suitable configurations.

In some embodiments, system 10 may comprise an external power source, such as a battery positioned within the hydraulic power source or elsewhere. Any suitable power source located at any suitable position may be used. In some embodiments, system may comprise any size, number, and configuration of electronic signal wiring operable to connect the power source and/or processor to system 10. It is contemplated that such electrical wiring may provide a physical connection or a wireless connection via any suitable combination of transmitters and receivers.

In some embodiments, the processor may provide logic control of system 10 using electronic signals indicating that the flow and/or pressure of hydraulic fluid within intermediate hydraulic system 10 needs to be modulated. Such signals may be generated periodically or continuously by signal generators in response to user inputs or changes in the environment of the signal generators. In some embodiments, signal generators may comprise an analogue or digital control mechanism actuated by an operator (e.g. a lever, switch, etc.). Such control mechanisms may be located near the operator within the hydraulic power source (i.e., the cab of the tractor). In other embodiments, signal generators may comprise sensors that measure changes in their local environment, including pressure (e.g., accumulator gauge, 36), temperature, location (i.e., GPS), electrical charge, etc. As will be appreciated, the generation and combination of signals by signal generators will be “read” by the electronic circuitry of processor (i.e., logic controller), which results in the at least one selector valve 20, the at least one accumulator 30, and the at least one controller valve 40 being actuated in a desired manner, in real time, to control the flow and pressure of hydraulic fluid received from the hydraulic power source and transferred to the hydraulic implement. For example, the combination of an operator setting a control mechanism to a “run” setting and GPS data indicating that the power source (i.e., tractor) has completed a pass of a field will generate signals indicating that certain pressure-driven mechanical devices within the hydraulic implement should be deactivated and the hydraulic implement should be raised from the ground (i.e., changing its demand for hydraulic power). The electronic circuitry of logic control processor will read those signals and cause the at least one selector valve 20, the at least one accumulator 30 (including bleed valves), and the at least one controller valve 40 to be actuated in an appropriate manner to ensure that a desired flow and pressure of hydraulic fluid is transferred to the implement (i.e. meet the changed demand for hydraulic power without drawing down excessive hydraulic power from the hydraulic power source). The number and type of signal generators required to automate intermediate hydraulic system 10 for use in any particular application will be appreciated.

Although a few embodiments have been shown and described, it will be appreciated by those skilled in the art that various changes and modifications can be made to these embodiments without changing or departing from their scope, intent, or functionality. These terms and expressions used in the preceding specification have been used herein as terms of description and not of limitation, and there is no intention in the use of such terms and expressions of excluding equivalents of the features shown and the described portions thereof.

We claim:

1. An intermediate hydraulic system for receiving hydraulic fluid from at least one hydraulic power source and transmitting the hydraulic fluid to at least one hydraulic implement, the intermediate hydraulic system comprising:
at least one selector valve having at least one input port for receiving hydraulic fluid into the valve, at least one of the input ports for receiving hydraulic fluid from the at least one hydraulic power source, and at least one output port for transmitting the hydraulic fluid to the at least on hydraulic implement,
at least one accumulator, in fluid communication with the at least one selector valve, the accumulator being adapted and configured to control pressure fluctuations in the hydraulic fluid,
at least one valve controller, in fluid communication with the at least one selector valve and that at least one accumulator, the at least one valve controller having at least one input port for receiving hydraulic fluid into the valve controller, and at least one output port for transmitting the hydraulic fluid out from the valve controller, and having at least one bleed valve for diverting hydraulic fluids from the system, and
at least one processor for controlling the system, for signaling the at least one selector valve, the at least one accumulator, and the at least one valve controller to regulate and maintain near-constant hydraulic fluid flow and pressure from the at least one hydraulic power source and to the at least one hydraulic implement in real time.

2. The intermediate hydraulic system of claim 1, wherein the at least one selector valve comprises at least three input ports for receiving hydraulic fluid into the valve, and at least three output ports for transmitting hydraulic fluid out from the valve.

3. The intermediate hydraulic system of claim 1, wherein the accumulator is a bladder accumulator.

4. The intermediate hydraulic system of claim 1, wherein the accumulator further comprises a hydraulic fluid pressure gauge configured for detecting and measuring hydraulic fluid pressure in the system.

5. The intermediate hydraulic system of claim 1, wherein the at least one controller valve comprises at least three input ports for receiving hydraulic fluid into the controller valve, and at least three output ports for transmitting hydraulic fluid out from the controller valve.

6. The intermediate hydraulic system of claim 1, wherein at least one valve controller further comprises at least one bleed valve.

7. The intermediate hydraulic system of claim 6, wherein the at least one bleed valve may be an automatic bleed valve, a manual bleed valve, or both.

8. The intermediate hydraulic system of claim 1, wherein the at least one signal generator is configured to transmit electrical signals corresponding with GPS data.

9. The intermediate hydraulic system of claim 1, wherein the at least one hydraulic power source is a tractor and the at least one hydraulic implement is hydraulic-pressure driven agricultural machinery.

10. The intermediate hydraulic system of claim 1, wherein the system is mobile.

11. The intermediate hydraulic system of claim 1, wherein the system is a closed-loop system.

12. A method of automatically controlling hydraulic fluid flow between at least one hydraulic power source and at least one hydraulic implement, the method comprising:
providing at least one selector valve in fluid communication with the at least one power source and the at least one hydraulic implement and configured to receive and transmit hydraulic fluid therebetween;
providing at least one hydraulic fluid accumulator in fluid communication with the at least one selector valve for controlling pressure fluctuations in the hydraulic fluid flow;
providing at least one selector valve controller in fluid communication with the at least one selector valve and the at least one accumulator configured to control hydraulic fluid flow therebetween; and
operating the at least one hydraulic power source to drive the at least one implement wherein, during operation, the at least one selector valve automatically actuated to transmit hydraulic fluid flow directly from the at least one hydraulic fluid source to the at least one hydraulic implement or to divert hydraulic fluid flow through the at least one accumulator and/or the at least one selector valve controller module to maintain near-constant hydraulic fluid pressure levels between the at least one hydraulic power source and the at least one hydraulic implement in real time.

13. The method of claim 12, wherein the near-constant pressure levels may be a predetermined level.

14. The method of claim 12, wherein the at least one hydraulic implement is towed by the at least one hydraulic power source.

15. The method of claim 12, wherein the at least one hydraulic power source is a tractor and the at least one hydraulic implement is hydraulic-pressure driven agricultural equipment.

16. The method of claim 12, further comprising providing a processor for controlling operation of the at least one selector valve, the at least one accumulator, and/or the at least one selector valve controller.

17. The method of claim 16, wherein the processor may be in electrical communication with the at least one hydraulic power source.

18. The method of claim 16, wherein the processor may be in electrical communication with a global positioning system of the at least one hydraulic power source.

19. The method of claim 12, wherein the method comprises providing a closed-loop hydraulic fluid control system electronically connected to onboard processing systems of the at least one hydraulic power source.
